(19) United States
(12) Patent Application Publication
(10) Pub. No.: US 2017/0064176 A1
(43) Pub. Date: Mar. 2, 2017

(54) APPARATUS FOR COMPENSATING FOR MOTION OF HANDHELD AND WEARABLE TERMINAL

(71) Applicant: ESSEL-T CO., LTD., Seongnam-si (KR)

(72) Inventor: Shin Ho KIM, Seongnam-si (KR)

(73) Assignee: ESSEL-T CO., LTD., Seongnam-si (KR)

(21) Appl. No.: 15/238,754

(22) Filed: Aug. 17, 2016

(30) Foreign Application Priority Data
Aug. 25, 2015 (KR) 10-2015-0119670

(51) Int. Cl. H04N 5/232; G03B 17/56; G02B 27/64

(52) U.S. Cl. CPC H04N 5/2328; G02B 27/644; G03B 17/561; G03B 17/563; G03B 17/566; H04N 5/23258; H04N 5/23206

(57) ABSTRACT

The apparatus for compensating for motion of a handheld and wearable terminal includes: a holder on which a portable terminal, having a photographing function, is detachably mounted; a gimbal portion, which is connected to the holder, and has a plurality of rotating units that provide a driving force to the holder and the portable terminal mounted on the holder so that the holder and the portable terminal rotate about a roll, a pitch and a yaw axis; a body portion, which is fixed to a rear end of the gimbal portion, and has an angular velocity sensor that detects movements of the three axes and generates a signal in response to the detected movements, and a controller that receives the signal generated by the angular velocity sensor to control driving of the gimbal portion; and a handle that is detachably fixed to a rear end of the body portion.

### CROSS-REFERENCE TO RELATED APPLICATION(S)

This application claims priority from Korean Patent Application No. 10-2015-0119670, filed on Aug. 25, 2015, in the Korean Intellectual Property Office, the entire disclosure of which is incorporated herein by reference for all purposes.

### BACKGROUND

1. Field

The following description generally relates to an apparatus for compensating for motion of a handheld and wearable terminal, and more particularly to an apparatus for compensating for motion of a handheld and wearable terminal, in which a rotational movement of a photographing apparatus may be sensed by using an angular velocity sensor, and the sensed motion may be compensated for.

2. Description of the Related Art

Recently, as portable terminals, such as Digital Single Lens Reflex (DSLR) cameras, Action cameras, smartphones, and the like, are widely used, there is a demand for increasing the number of pixels, while decreasing the size, of camera modules of such portable terminals. In order to satisfy the demand for increasing the number of pixels, the pixel size of image sensors is decreased to allow a large number of pixels in a limited image sensor area.

In addition, as the pixel size of image sensors is decreased, the definition of still images may be significantly reduced even by a minute motion of a camera module which is caused when a user presses a shutter release to capture still images.

Further, even in the case where the pixel size of sensors is not small, there may be continuous motion or movement of a camera when recording video images due to a user's movement or recording for a long period of time.

Only expert-level users may have a photographing technique that does not cause such motion of a camera module, while ordinary users may cause unnatural motion of recorded images between frames when recording video images. Particularly, with the widespread use of High-Definition (HD) TVs, video images of high-definition are widely used, in which the number of pixels in HD video images is greater than the number of pixels in Standard-Definition (SD) images. For this reason, shaking of a user's hand or movements of a user may make undesirable motion in the captured images more clearly visible, thereby resulting in video images of low quality and low degree of completion.

Accordingly, there is a need for a portable terminal holder that may enable recording of HD video images with high quality and high degree of completion by automatically compensating for camera module shakes or a user's movements.

### SUMMARY

The present disclosure provides an apparatus for compensating for motion of a handheld and wearable terminal, in which an amount of rotational movement of a portable terminal, which is caused by a user's movement or shaking, is detected by using a gyro sensor that detects an angular velocity, and motion of the portable terminal is compensated for in an amount corresponding to the amount of rotational movement by moving the portable terminal in a reverse direction, so that high quality images may be acquired without shaking or motion of a portable terminal.

In one general aspect, there is provided an apparatus for compensating for motion of a handheld and wearable terminal, the apparatus including: a holder on which a portable terminal, having a photographing function, is detachably mounted; a gimbal portion, which is connected to the holder, and has a plurality of rotating units that provide a driving force to the holder and the portable terminal mounted on the holder so that the holder and the portable terminal rotate about a roll axis, a pitch axis, and a yaw axis; a body portion, which is fixed to a rear end of the gimbal portion, and has an angular velocity sensor that detects movements of the three axes and generates a signal in response to the detected movements, and a controller that receives the signal generated by the angular velocity sensor to control driving of the gimbal portion; and a handle that is detachably fixed to a rear end of the body portion.

### BRIEF DESCRIPTION OF THE DRAWINGS

FIG. 1 is a perspective view of an apparatus for compensating for motion of a handheld and wearable terminal according to an exemplary embodiment.

FIG. 2 is a perspective view of the apparatus in FIG. 1 with a terminal being mounted on a holder according to an exemplary embodiment.

FIG. 3 is a perspective view of the apparatus in FIG. 1 with a handle being separated from a body portion according to an exemplary embodiment.

FIG. 4 is a perspective view of the apparatus in FIG. 3 with a body of a handle being separated from a remote control according to an exemplary embodiment.

FIG. 5 is a perspective view of the apparatus in FIG. 1 with an adapter being mounted on a body portion, from which a handle is separated, according to an exemplary embodiment.

FIG. 6 is a perspective view illustrating an example of mounting, on a helmet, an apparatus for compensating for motion of a portable terminal having an adapter.

FIG. 7 is a block diagram illustrating an apparatus for compensating for motion of a handheld and wearable terminal according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

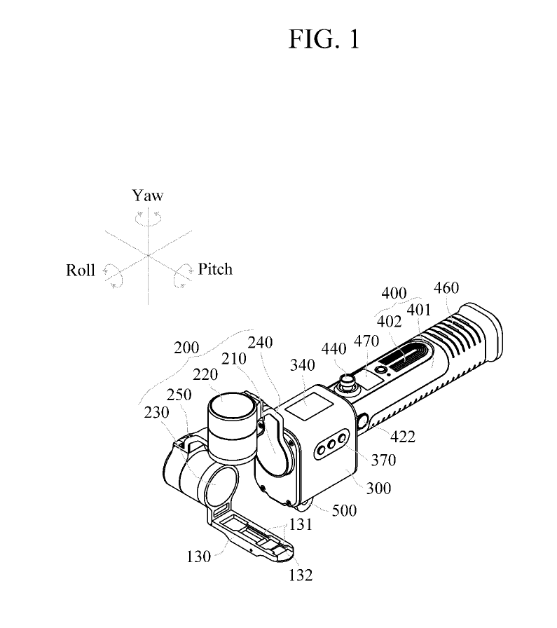

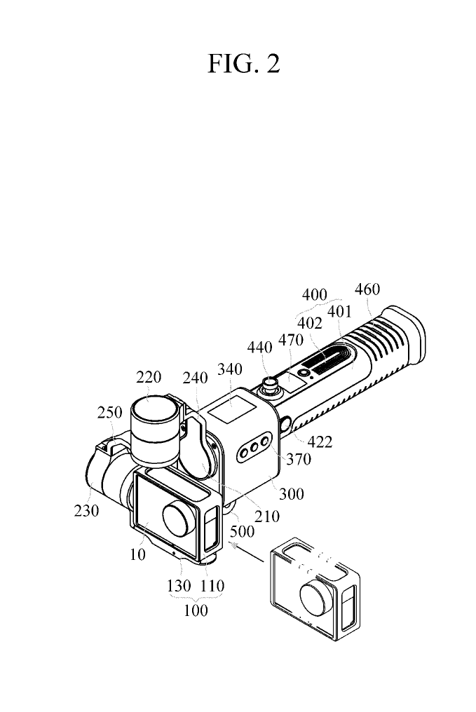

The present disclosure provides an apparatus for compensating for motion of a handheld and wearable terminal, in which a rotational movement of a photographing apparatus is sensed by using an angular velocity sensor, and the sensed movement may be compensated for, and embodiments thereof will be described below with reference to FIGS. 1 and 2.

FIG. 1 is a perspective view of an apparatus for compensating for motion of a handheld and wearable terminal according to an exemplary embodiment. FIG. 2 is a perspective view of the apparatus in FIG. 1 with a terminal being mounted on a holder according to an exemplary embodiment.

The apparatus for compensating for motion of handheld and wearable terminal includes a holder 100, a gimbal portion 200, a body portion 300, and a handle 400.

The holder 100 is a portion where a portable terminal 10 having an image sensor for capturing images is detachably mounted, and connects the portable terminal 10 to the gimbal portion 200. The holder 100 may be formed in various shapes, such as a cover to protect all sides of the portable terminal 10, or a bar that contacts one side of the portable terminal 10. The holder 100 may be integrally formed with the gimbal portion, and may be formed in various manners as long as the portable terminal 10 may be easily detached from the holder 10.

The gimbal portion 200 is connected with the holder 100, and has a plurality of rotating units 210, 220, and 230 to provide a driving force for rotating the portable terminal 10 about a roll axis, a pitch axis, and a yaw axis. For example, the rotating units 210, 220, and 230 may be motors. The rotating units 210, 220, and 230 may be separated into the rotating unit 210 that rotates about the roll axis, the rotating unit 220 that rotates about the pitch axis, and the rotating unit 230 that rotates about the yaw axis, and the rotating units 210, 220, and 230 may be arranged in a manner that does not interfere with each other while rotating.

The body portion 300 has a front end to which a rear end of the gimbal portion 200 is fixed, and has a rear end to which the handle 400 is fixed. The body portion 300 includes: an angular velocity sensor 310 that detects movements of three axes of the body portion 300, the holder 100, and the portable terminal 10 mounted on the holder 100, and generates a signal in response to the detected movement; and a controller 320 that receives a signal from the angular velocity sensor 310 to control the operation of the gimbal portion 200.

The angular velocity sensor 310 may be various sensors as long as the sensor may sense an angular velocity of rotation of the body portion 300, the holder 100, or the portable terminal 10 mounted on the holder 100, and may be, for example, a gyro sensor.

The controller 320 controls the operation of the rotating units 210, 220, and 230 by calculating control values for moving the portable terminal 110, so as to compensate for rotational movements of the body portion 300, the holder 100, or the portable terminal 10 mounted on the holder 100. For example, the controller 320 may be a microprocessor.

Additionally, the body portion 300 may further include a power supply 360 that supplies power to the angular velocity sensor 310, the controller 320, and the rotating units 210, 220, and 230. The power supply 360 may include a battery and a charging module. The body portion 300 may have a button 370 to turn on/off power, or to input various commands, such as a command for setting an operation mode of the gimbal portion 200; and an input unit, such as a touch screen, a joystick, a dial, and the like.

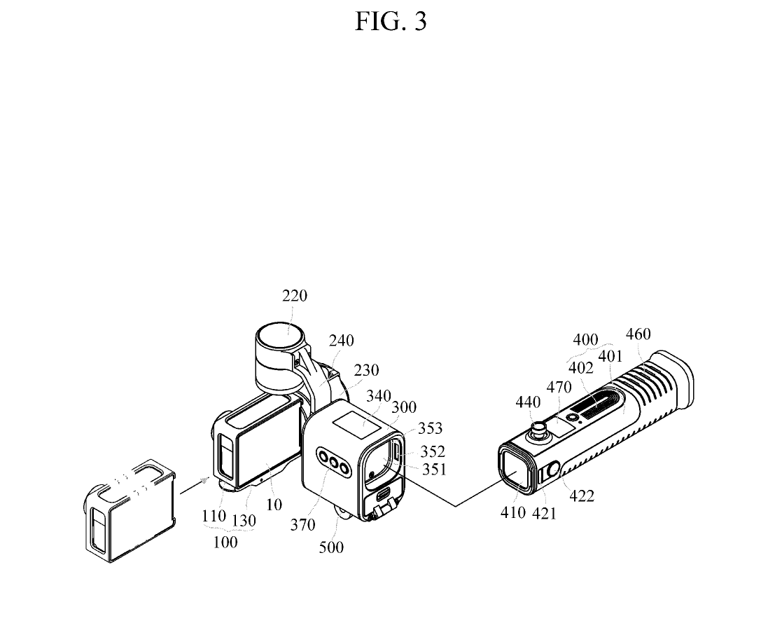

FIG. 3 is a perspective view of the apparatus in FIG. 1 with a handle being separated from a body portion according to an exemplary embodiment.

As illustrated in FIG. 3, the handle 400 is detachably fixed to a rear end of the body portion 300. In a handheld mode in which the handle 400 is connected to the body portion 300, a user may capture video images by using the portable terminal 10 mounted on the holder 100 while holding the handle 400 that is connected to the body portion 300. Further, in a wearable mode in which the handle 400, if not needed, is separated from the body portion 300, a user may capture images by using the portable terminal 10 mounted on the holder 100 while mounting the body portion 300 on wearable equipment 20 and the like. That is, in a handheld mode, images are captured while the handle 400 is connected to the body portion 300, and in a wearable mode, images are captured while the handle 400 is separated from the body portion 300.

As described above, an amount of rotational movement of the portable terminal 10, which is caused by shaking of a user's hand or movements of a user, may be detected by using an angular velocity sensor 310 that detects an angular velocity, and the rotational movement of the portable terminal 10 may be compensated for by moving the portable terminal 10 in an amount corresponding to the amount of rotational movement, such that high quality images may be acquired without motion of the portable terminal 10. Further, images may be captured in a handheld mode where the handle 400 is connected to the body portion 300, or in a wearable mode where the handle 400 is separated from the body portion 300, and the body portion 300 is mounted on equipment, such as a helmet, a bicycle, and the like. In this manner, image capturing modes may be changed according to circumstances.

In another exemplary embodiment, the holder 100 includes: a cover 110 that is fixed to the portable terminal 10 in a manner that covers the lateral surface of the portable terminal 10; a fixing piece 120 having a projection 122 that projects on the bottom of the cover 110, and a fixing groove 121 that is concavely formed on both sides of the projection 122 in a width direction; and a mounting bar 130 having one end that is fixed to the gimbal portion 200, and including a groove 132 and a fixing projection 131 formed in the width direction to face the projection 122 and the fixing groove 121, so that the fixing piece 120 may be slidably fitted on the top surface of the mounting bar 130. That is, the mounting bar 130 has on the top surface an inwardly concave space, and has on both sides the fixing projection 131 and the groove 132 that face each other, in which the fixing projection 131 projects to be fitted into the fixing groove 121, and the groove 132 is formed to be concave, relative to the fixing projection 131, on the bottom of the fixing projection 131, so that the projection 122 may be fitted into the groove 132. Accordingly, the cover 110 fixed to the portable terminal 10 may be slidably fitted into the mounting bar 130 from other side to one side in such a manner that the projection 122 and the fixing groove 121 of the fixing piece 120 are fitted into the groove 132 and the fixing projection 131 of the mounting bar 130 that is fixed to the gimbal portion 200.

Further, after the cover 110 is slidably fitted into the mounting bar 130, the cover 110 and the mounting bar 130 may be coupled by a bolt 140 and the like to enhance coupling therebetween. The bolt 140 may be used not only for the cover 110 but also for the portable terminal 10.

In another exemplary embodiment, the gimbal portion 200 includes: a first rotating unit 210 that is mounted on the body portion 300 to rotate about a roll axis; a second rotating unit 220 that is formed on the front upper portion of the first rotating unit 210 to rotate about a yaw axis; a first connecting member 240 that connects the first rotating unit 210 and the second rotating unit 220; a third rotating unit 230 that is formed on the bottom of one side of the second rotating unit 220 to rotate about a pitch axis; and a second connecting member 250 that connects the second rotating unit 220 and the third rotating unit 230.

The first rotating unit 210 rotates about a roll axis, and may be embedded in a front end of the body portion 300. The second rotating unit 220 rotates about a yaw axis, and is disposed on a front upper portion of the first rotating unit 210. The third rotating unit 230 is disposed on the bottom of one side of the second rotating unit 220 to rotate about a pitch axis. The first connecting member 240 connects the first rotating unit 210 and the second rotating unit 220. The second connecting member 250, which connects the second rotating unit 220 and the third rotating unit 230, has an embedded electric wire and the like to electrically connect the controller 320, the second rotating unit 220, and the third rotating unit 230, and to provide electric current supplied from the power supply 360.

For example, the first rotating unit 210, the second rotating unit 220, and the third rotating unit 230 may be motors, more particularly, waterproof brushless DC motors to secure waterproof property and security. Each of the rotating units 210, 220, and 230 may be connected to motor drives 211, 221, and 231 that controls driving of motors.

Accordingly, the controller 320 calculates control values for moving the portable terminal 10 to compensate for rotational movements of the body portion 300, the holder 100, and the portable terminal 10 mounted on the holder 100, and controls the motor drives 211, 221, and 231 to drive the first rotating unit 210, the second rotating unit 220, and the third rotating unit 230.

In another exemplary embodiment, the body portion 300 has a display 340 to display specific information. The display 340 may be a liquid crystal display (LCD), a light emitting diode (LED), an organic light emitting diode (OLED), and the like, and may display commands input by a user to the controller 320, an operation status and a current operation mode of the gimbal portion 200, a battery remaining capacity, or the like, so that a user may check such information in real time.

In addition, the handle 400 may have the display 470, on which commands input by a user to the controller 320, an operation status and a current operation mode of the gimbal portion 200, a battery remaining capacity, or the like, may be displayed.

In yet another exemplary embodiment, a receiving portion 351, which is inwardly concave, is formed on a rear end of the body portion 300 so that the front end of the handle 400 is inserted into the receiving portion 351. A detachable groove 352 is formed on one side or both sides of an inner surface of the receiving portion 351. Further, a detachable projection 410 is formed along the circumference of the front end of the handle 400 to be inserted into the receiving portion 351, and a hook-shaped snap 421, which is fixed to the detachable groove 352 by snap-on engagement, is formed on one side or both sides of the handle 400.

The snap 421 has an inclined surface that is upwardly inclined from a front end to a rear end, and a push-button 422 that is connected with the snap 421 is formed on one side or both sides of the handle 400. Accordingly, the handle 400 may be fixed to the body portion 300 in such a manner that the detachable projection 410 of the handle 400 is inserted into the receiving portion 351 of the body portion 300 while pressing the push-button 422, and then by releasing the push-button 422, the snap 421 is extended outwardly to be inserted into the detachable groove 352.

Further, the handle 400 may be separated from the body portion 300 in such a manner that the snap 421 is detached from the detachable groove 352 by pressing the push-button 422, and then the detachable projection 410 is detached from the receiving portion 351.

In still another exemplary embodiment, a magnet or iron may be provided for the receiving portion 351 of the body portion 300 and the detachable projection 410 of the handle 400 to couple the body portion 300 and the handle 400 by a magnetic force.

That is, in order to produce a magnetic attraction between the receiving portion 351 and the detachable projection 410, magnets having different polarities may be embedded in the receiving portion 351 and the detachable projection 410, or a magnet may be embedded in the receiving portion 351 and iron may be embedded in the detachable projection 410, or iron may be embedded in the receiving portion 351 and a magnet may be embedded in the detachable projection 410.

In addition, a cable terminal 380 may be included in the receiving portion 351, and a shock-absorbing member 353, such as rubber or silicone material, may be provided along the inner circumference of the receiving portion 351 so as to reduce shock that may be caused when the detachable projection 410 of the handle 400 contacts the inner surface of the receiving portion 351.

In yet another exemplary embodiment, a manipulator 440 that is connected with the controller 320 through a wired or wireless network to input various signals for operation of the gimbal portion 200 may be formed. Accordingly, while the handle 400 is connected to the body portion 300, a user, while holding the handle 400, may input various commands to operate the gimbal portion 200 through the manipulator 440 formed on the handle 400. Further, even when the handle 400 is separated from the body portion 300, a user may control the operation of the gimbal portion 200 by only carrying the handle 400.

The manipulator 440 may be connected with the controller 320 through a wired or wireless network for communication, and may receive input of commands by using a button, a touch screen, a joystick, a jog key, a dial, and the like.

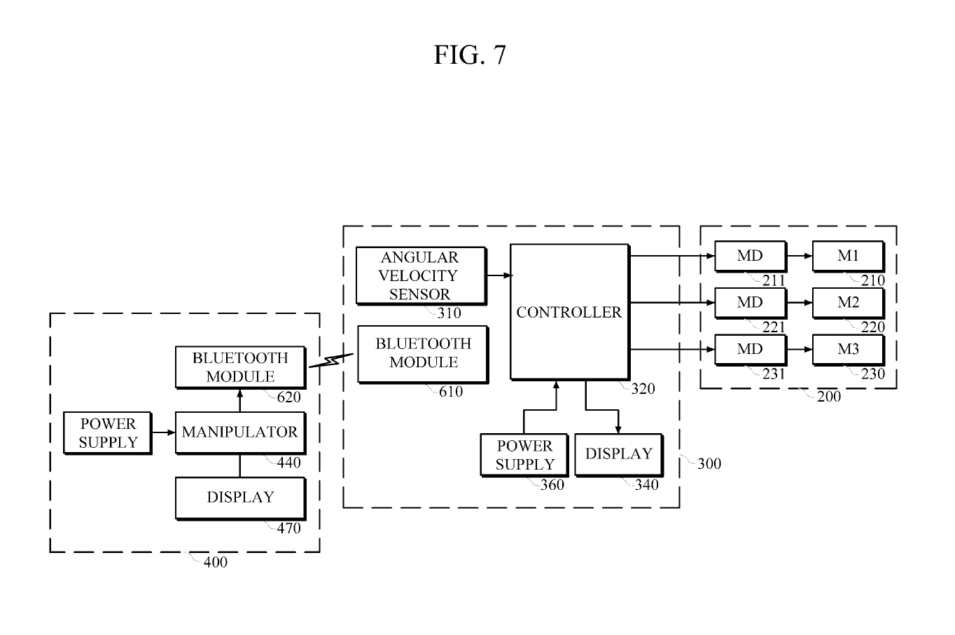

FIG. 7 is a block diagram illustrating an apparatus for compensating for motion of a handheld and wearable terminal according to an exemplary embodiment.

In the exemplary embodiment, Bluetooth modules 610 and 620 are mounted on the body portion 300 and the manipulator 440 respectively, such that the controller 320 may be manipulated wirelessly by the manipulator 440. For example, a Bluetooth receiver is embedded in the body portion 300 to be electrically connected to the controller 320, and a Bluetooth transmitter is embedded in the manipulator 440 for Bluetooth communication between the controller 320 and the manipulator 440, so that various signals for operation of the gimbal portion 200 may be wirelessly transmitted to the controller 320 through the manipulator 440 of the handle 400.

Further, various known wireless communication devices may be mounted in the body portion 300 and the manipulator 440 to enable various wireless communications, such as WiFi and the like, as well as Bluetooth communication.

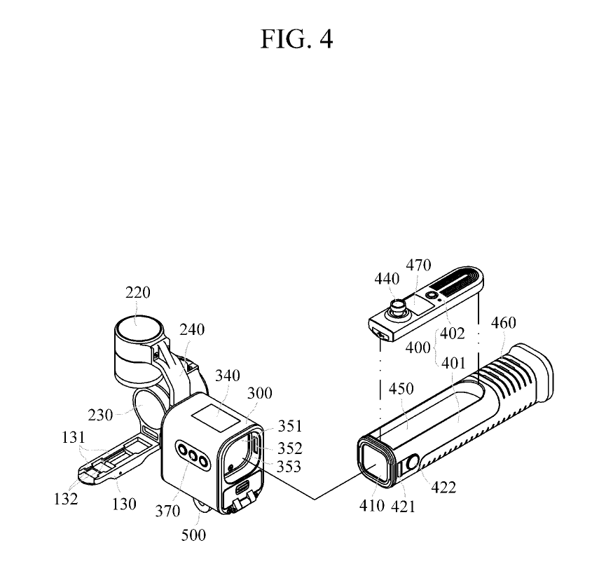

FIG. 4 is a perspective view of the apparatus in FIG. 3 with a body of a handle being separated from a remote control according to an exemplary embodiment.

In the exemplary embodiment, the handle 400 includes, on one side, a body 401 having a receiving space 450 that is inwardly concave; and a remote control 402 that is detachably inserted into the receiving space 450. The manipulator 440 is provided in the remote control 402. Accordingly, while the handle 400 is separated from the body portion 300, the controller 320 of the body 401 may be manipulated by separating the remote control 402 from the body 401 and by only carrying the remote control 402 that is relatively lightweight compared to the body 401. In this case, the controller 320 may be wirelessly manipulated by the Bluetooth module 620 embedded in the remote control 402.

In another exemplary embodiment, a magnet or iron is provided for the body 401 or the remote control 402, so that the body 401 and the remote control 402 may be connected to each other by a magnetic force therebetween.

That is, in order to produce a magnetic attraction between the body 401 and the remote control 402, magnets having different polarities may be embedded in the body 401 and the remote control 402, or a magnet may be embedded in the body 401 and iron may be embedded in the remote control 402, or iron may be embedded in the body 401 and a magnet may be embedded in the remote control 402.

Accordingly, the remote control 402 may be fixed to the body 401 more firmly by a magnetic force, thereby facilitating attachment and detachment of the remote control 402.

In yet another exemplary embodiment, the handle 400 has, on a rear end, a grip 460 made of an elastic material for providing an enhanced sense of feel of the grip. The grip 460, which may be made of rubber or silicone material, may provide a frictional force, thereby preventing the handle 400 from slipping out of a user's hand.

In still another exemplary embodiment, the handle 400 has a hollow storage space to store various belongings inside the handle 400, and a lid may be provided on an end portion of the handle 400 to open or close the storage space.

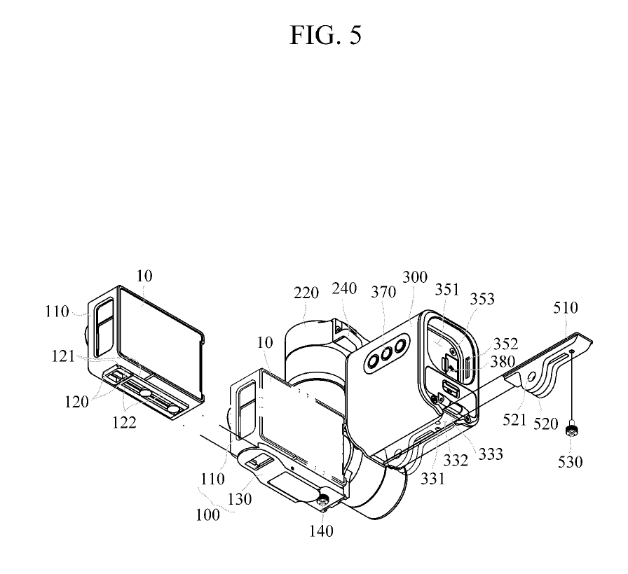

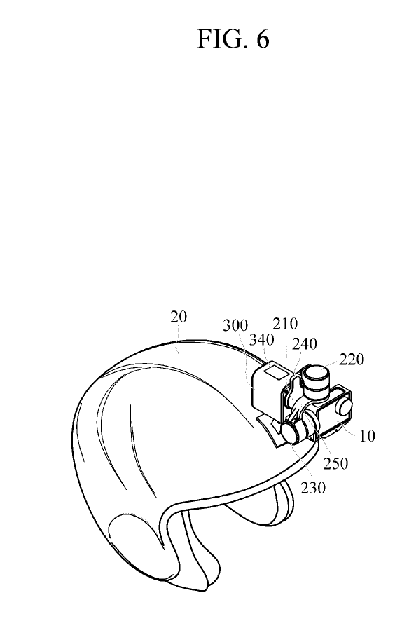

FIG. 5 is a perspective view of the apparatus in FIG. 1 with an adapter being mounted on a body portion, from which a handle is separated, according to an exemplary embodiment. FIG. 6 is a perspective view illustrating an example of mounting, on a helmet, an apparatus for compensating for motion of a portable terminal having an adapter.

In one exemplary embodiment, the body portion 300 has, on one surface, an adapter 500 that is connected to wearable equipment 20.

The adapter 500 is formed on one surface of the body portion 300, and may be coupled to the wearable equipment 20, such as a helmet, an arm band, and the like, by using an adapter, bolts, and the like of a bicycle, a drone, and the like. Accordingly, the adapter 500 may have a through-hole 521 for bolt coupling.

The adapter 500 may be detachably fixed to the body portion 300, such that the adapter 500 may be readily detached according to circumstances.

As described above, the adapter 500, which is connected to a user's body part or to other wearable equipment 20, is formed on the side of the body portion 300, such that the height of the apparatus may be lowered, and no external interference occurs, thereby stabilizing operations of the portable terminal 10.

In another exemplary embodiment, the body portion 300 has on one side a coupling projection 331, which projects outwardly, and includes an opening 332 that is formed at a center portion of the coupling projection 331 in a longitudinal direction, and a coupling groove 333 that is connected to the opening 332 and is concavely formed on both inner sides of the coupling projection 331.

Further, the adapter 500 has on one side a coupling plate 510, both ends of which are slidably fitted into the coupling groove 333 so that the adapter 500 may be fixed to the body portion 300, and a projection portion 520 having the through-hole 521 projects outwardly through the opening 332. A pair of the projection portion 520, which are spaced apart from each other, may be fixed to the coupling plate 510. The adapter of the wearable equipment 20 is inserted into the pair of projection portions 520, which project outwardly through the opening 332, and the body portion 300 may be coupled to the wearable equipment 20 by a bolt through the through-hole formed in the adapter.

Further, after the coupling plate 510 is fitted into the coupling groove 333 of the body portion 300, a bolt 530 or the like may be used to enhance coupling between the coupling plate 510 and the body portion 330 so that the coupling plate 510 and the body portion 330 may be coupled more firmly.

As described above, an amount of rotational movement of a portable terminal, which is caused by a user's movement or shaking, is detected by using a gyro sensor that detects an angular velocity, and motion of the portable terminal is compensated for in an amount corresponding to the amount of rotational movement by moving the portable terminal in a reverse direction, so that high quality images may be acquired without shaking or motion of a portable terminal.

Further, images may be captured by holding with a hand a holder, on which a portable terminal having an embedded image sensor is mounted, or by mounting the holder, without a handle, on equipment, such as a helmet, a bicycle, and the like. In this manner, images may be captured by easily changing the holder mode according to circumstances.

Moreover, in the apparatus for compensating for a handheld and wearable terminal, an adapter, which is mounted on a user's body part or other equipment, is formed on the side of a body portion, such that the height of the apparatus may be lowered, and no external interference occurs, thereby stabilizing operations of a portable terminal.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims. Further, the above-described examples are for illustrative explanation of the present invention, and thus, the present invention is not limited thereto.

What is claimed is:

1. An apparatus for compensating for motion of a handheld and wearable terminal, the apparatus comprising:
a holder on which a portable terminal, having a photographing function, is detachably mounted;
a gimbal portion, which is connected to the holder, and has a plurality of rotating units that provide a driving force to the holder and the portable terminal mounted on the holder so that the holder and the portable terminal rotate about a roll axis, a pitch axis, and a yaw axis;
a body portion, which is fixed to a rear end of the gimbal portion, and has an angular velocity sensor that detects movements of the three axes and generates a signal in response to the detected movements, and a controller that receives the signal generated by the angular velocity sensor to control driving of the gimbal portion; and
a handle that is detachably fixed to a rear end of the body portion.

2. The apparatus of claim 1, wherein the holder comprises:
a cover that is fixed to the portable terminal in a manner that covers a lateral surface of the portable terminal;
a fixing piece that projects on a bottom of the cover, and has on both sides a fixing groove in a width direction; and
a mounting bar having one end that is fixed to the gimbal portion, and including a fixing projection formed in the width direction to face the fixing groove, so that the fixing piece is slidably fitted on a top surface of the mounting bar.

3. The apparatus of claim 1, wherein the gimbal portion comprises:
a first rotating unit mounted on the body portion to rotate about the roll axis;
a second rotating unit formed on a front upper portion of the first rotating unit to rotate about the yaw axis;
a first connecting member that connects the first rotating unit and the second rotating unit;
a third rotating unit formed on a bottom of one side of the second rotating unit to rotate about the pitch axis; and
a second connecting member that connects the second rotating unit and the third rotating unit.

4. The apparatus of claim 1, wherein the body portion has on one side an adapter that is connected to wearable equipment.

5. The apparatus of claim 4, wherein:
the body portion has on one side a coupling projection, which projects outwardly, and includes an opening formed at a center portion of the coupling projection in a longitudinal direction, and a coupling groove formed on both inner sides of the coupling projection; and
the adapter has on one side a coupling plate, both ends of which are slidably fitted into the coupling groove, so that the adapter is fixed to the body portion and projects outwardly through the opening.

6. The apparatus of claim 1, wherein body portion includes a display that displays specific information.

7. The apparatus of claim 1, wherein:
the body portion has on a rear end a receiving portion, which is inwardly concave so that a front end of the handle is inserted into the receiving portion, and a detachable groove is formed on one side or both sides of an inner surface of the receiving portion,
wherein a detachable projection is formed along the circumference of the front end of the handle to be inserted into the receiving portion, and a hook-shaped snap, which is fixed to the detachable groove by snap-on engagement, is formed on one side or both sides of the handle.

8. The apparatus of claim 1, wherein the handle has a manipulator which is connected to the controller through a wired or wireless network, and inputs various signals for operation of the gimbal portion.

9. The apparatus of claim 8, wherein Bluetooth modules are provided for the body portion and the manipulator, so that the controller is wirelessly manipulated by the manipulator.

10. The apparatus of claim 8, wherein:
the handle has on one side a body with a receiving space that is inwardly concave and a remote control that is detachably inserted into the receiving space; and
the manipulator is provided in the remote control.

11. The apparatus of claim 10, wherein a magnet or iron is provided for the body or the remote control, such that the body or the remote control are coupled with each other by a magnetic force.

12. The apparatus of claim 1, wherein the handle has on a rear end a grip made of an elastic material to enhance sense of feel of the grip.
